(19) United States
(12) Patent Application Publication
(10) Pub. No.: US 2012/0240848 A1
(43) Pub. Date: Sep. 27, 2012

(54) POWDER DISPENSER FILTRATION SYSTEM

(76) Inventor: Doug Amundsen, New Prague, MN (US)

(21) Appl. No.: 13/052,340

(22) Filed: Mar. 21, 2011

(51) Int. Cl. B05C 3/09; B01D 46/42

(52) U.S. Cl. 118/429; 55/383

(57) ABSTRACT

A powder dispensing system comprises an enclosure, a grate, a tub, an air filter and a fan. The enclosure has an upper opening and a lower opening. The grate extends across the upper opening. The tub holds powder and is supported by the grate. The air filter is supported within the enclosure beneath the grate. The fan is coupled to the housing and configured to force air from the enclosure through the lower opening.

### BACKGROUND

The present invention relates generally to powder dispensing systems for use in gymnasiums. In particular, the present invention relates to powder dispensing systems having filtration systems.

Gymnasiums provide facilities and equipment that athletes use to train. Typical gymnasiums include weightlifting equipment and more generally equipment on which a sure grip is desirable for both performance and safety. In particular, gymnasiums configured for training in gymnastics include many stations and pieces of equipment upon which the gymnast must support his or her own weight by gripping a handle or engaging a surface with the palm of the hand. It is therefore quite apparent that a firm grip is desirable. Moisture, particularly from sweat and perspiration, severely diminishes the effectiveness of an athlete's grip. Athletes and gymnasts, therefore, often use a powder, such as chalk (magnesium carbonate) or talcum (magnesium silicate), to prevent the negative effects of sweat and moisture and to enhance grip.

Gymnasiums typically provide chalk dispensers for the convenience of the athletes at various locations throughout the gymnasium. Typical dispensers comprise simple bowls supported on pedestals at a convenient, typically waist-level, height. Powdered chalk is provided within the bowls along with larger blocks or balls of solidified chalk powder that the athletes handle to apply chalk to their hands. Such dispensers provide adequate means for supporting and dispensing the chalk to athletes. For example, athletes prefer to lift the solidified chalk powder from the bowls to rub them or roll them between their hands. Furthermore, athletes typically clap their hands over the bowl to remove unwanted excess powder. These dispensers, however, do not adequately dispense the chalk in a manner conducive to safe operation of the gymnasium. Specifically, such dispensers result in non-trivial amounts of powder entering the air in the gymnasium, which produces an unhealthy breathing environment. Furthermore, such dispensers also result in powder dust, as well as small chunks and pieces of the solidified chalk powder, being dropped to the floor of the gymnasium. These side effects waste chalk and produce slippery and potentially hazardous floors in the gymnasium.

Various systems have been developed in attempts to alleviate problems associated with loose chalk powder in gymnasiums. For example, some gymnasiums use air filtration systems. Even though these filtration systems can be positioned near the powder dispensers, powder is still free to float into the atmosphere in directions away from the filtration system. Often these systems are prohibitively expensive. Most chalk powder, however, is not caught by the filter and settles on the floor where it remains until swept up with a broom or mop. Furthermore, air filters do not prevent solidified pieces of chalk powder from leaving the bowl and falling to the floor, where they become dirty or get crushed. Other filter systems, such as described in U.S. Pat. No. 6,116,480 to Dufort, provide an enclosure around the chalk bowl into which athletes place their hands to acquire chalk powder. Air from within the enclosure is pulled up from a pan and then down through a tube and a filter by a fan such that powder is removed from the air near the dispenser. However, systems that include such enclosures are disfavored by athletes because the enclosures inhibit free movement of hands. As such, there is a need for a chalk dispenser filtration system that addresses cleanliness and safety issues of the gymnasium, but that is also expediently useable by athletes and inexpensive.

### SUMMARY

The present invention is directed generally to systems for dispensing powder, such as for use in athletic venues. More specifically, the invention relates to powder filtration and recycling systems used in conjunction with such powder dispensers. A powder dispensing system comprises an enclosure, a grate, a tub, an air filter and a fan. The enclosure has an upper opening and a lower opening. The grate extends across the upper opening. The tub holds powder and is supported by the grate. The air filter is supported within the enclosure beneath the grate. The fan is coupled to the housing and configured to force air from the enclosure through the lower opening.

### BRIEF DESCRIPTION OF THE DRAWINGS

FIG. 1 is a front perspective view of a powder dispenser filtration system of the present invention showing an enclosure having a powder bin mounted on a grate and a fan.

FIG. 2 is a top perspective view of the powder dispenser filtration system of FIG. 1 showing partial views of a grate, a screen and a filter situated above a fan.

FIG. 3 is a cross-sectional view of the powder dispenser filtration system taken at section 3-3 of FIG. 2 showing airflow through the system.

FIG. 4 is a cross-sectional view of the powder dispenser filtration system taken at section 4-4 of FIG. 1 showing the grate, the screen and the filter supported on rails.

### DETAILED DESCRIPTION

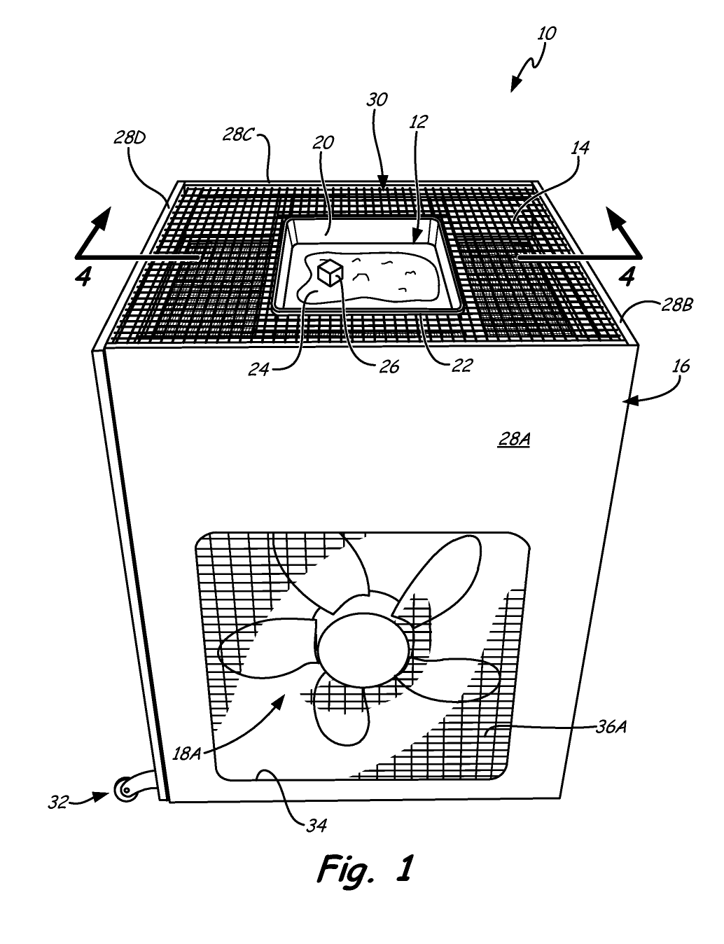

FIG. 1 is a perspective view of powder dispenser filtration system 10 of the present invention. Powder dispenser filtration system 10 includes powder dispenser 12, grate 14, enclosure 16 and first fan 18. Powder dispenser 12 comprises tub 20 and flange 22. Located within tub 20 is powder 24 and block 26. Enclosure 16 comprises panels 28A, 28B, 28C and 28D, which form upper opening 30. Panel 28D includes wheel 32. Panel 28A includes first lower opening 34. First fan 18A includes grill 36A.

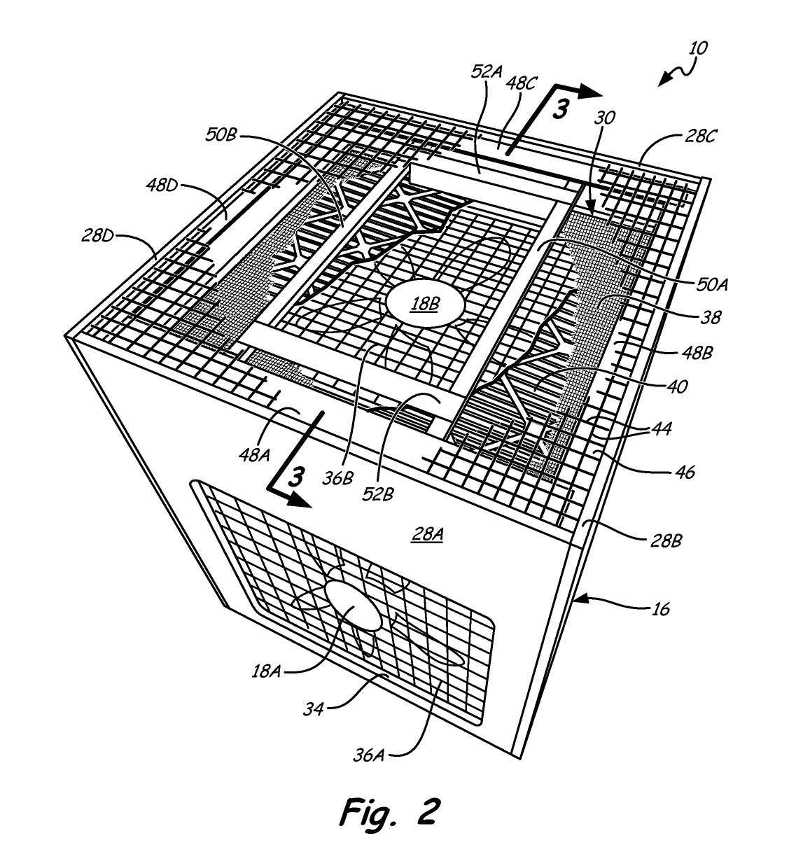

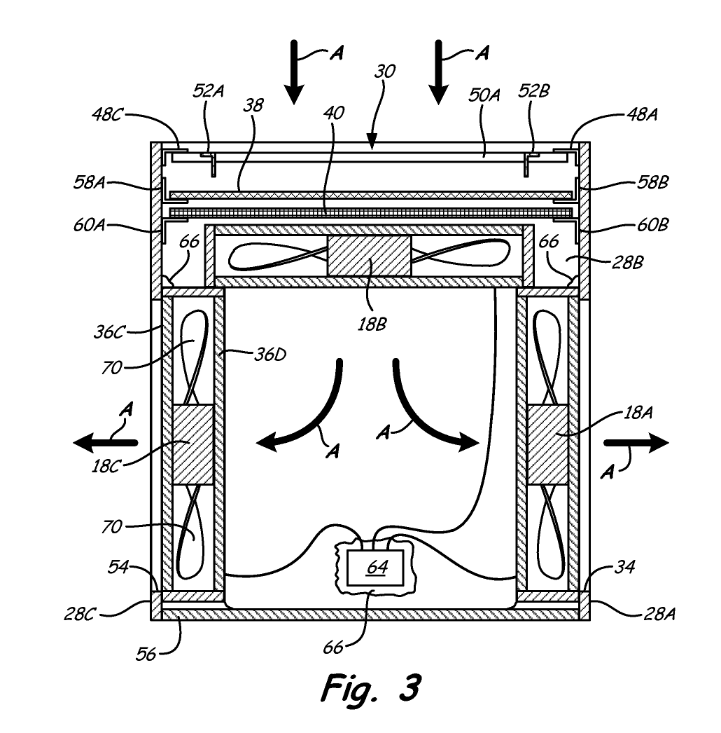

Enclosure 16 comprises a plurality of panels arranged to form a housing having an interior. In the embodiment shown, enclosure 16 includes four square panels 28A-28D arranged in a cube or box-like formation. Panels 28A-28D are comprised of any material suitable for providing structural stability, such as wood or plastic. Panels 28A-28D are closed by a floor panel (FIG. 3) to from an open-ended enclosure. The top end of panels 28A-28D are open at upper opening 30 to receive grate 14, which is supported by rails (FIG. 2) extending between panels 28A-28D. Panels 28A-28D and the floor panel are secured using adhesive or mechanical fasteners.

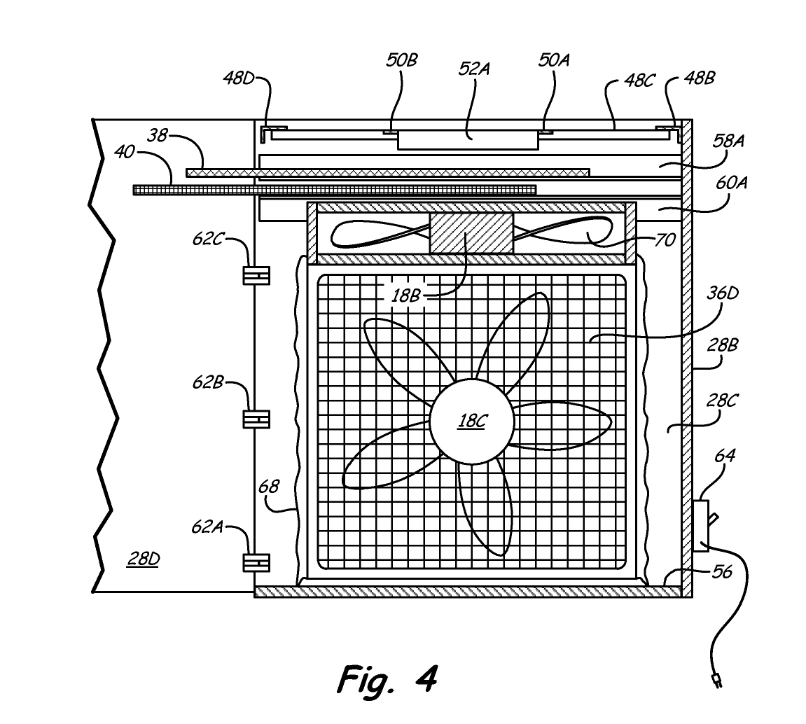

Panel 28D is configured as a door to provide access to the interior of enclosure 16. Panel 28D is mounted on hinges (FIG. 4) connected to panel 28C and includes wheel 32 that allows panel 28D to pivot smoothly in a supported manner on the hinges. In the embodiment shown, wheel 32 comprises a caster. Panel 28A includes first lower opening 34 in which first fan 18A is disposed. Fan 18A is oriented such that the enclosed fan blades blow air out of enclosure 16 through opening 34. The fan blades are mounted within a housing structure covered by grill 36A on one end a second grill on the other end (FIG. 3), as in a typical box fan configuration. With panel 28D closed, enclosure 16 is substantially sealed such that air can be drawn into grate 14 and expelled through grill 36A. For example the joints between panels 28A-28D can be sealed such as with caulk or silicone-based sealant. Alternatively, a rubber gasket may be positioned adjacent between panels. In the embodiment shown, fan 18A is secured to the inside of panel 28A using an insulating foam sealant. However, fan 18A may be secured to the exterior of enclosure 16, or may be mechanically fastened and sealed with a gasket. In the disclosed embodiment, three box fans are used to drive air through enclosure 16, as shown in FIG. 3.

Grate 14 includes an opening in which powder tub 20 of dispenser 12 is disposed. Flange 22 extends around the periphery of tub 20 to prevent powder dispenser 12 from passing through the opening in grate 14. Tub 20 comprises a bin or container for storing a material to be dispensed, such as chalk powder. Specifically, tub 20 is sized to hold a number of larger solid pieces in a mass of powder. In the embodiment shown, tub 20 comprises a rectangular plastic pan having a top-located access point. Grate 14 surrounds tub 20 to form an apron at a height convenient for accessing powder 24 and block 26 within tub 20. For example, grate 14 is approximately waist-high for a typical user.

Powder dispenser filtration system 10 comprises a stand or station at which an athlete can obtain hand-drying powders such as chalk before performing maneuvers. A large, top-located opening permits the athlete to obtain and handle the powder without interference from powder dispenser 12. As such that the athlete can perform whatever procedures or rituals necessary or familiar to the athlete to prepare for executing the maneuvers. The powder is typically stored in the form of large solid blocks 26 that are placed within a loose mixture of powder 24 and smaller chunks. The athlete may prefer to rub powder 24 directly onto his or her hands or may prefer to manipulate larger blocks 26 to obtain the desired amount of chalk. In so doing, the chalk is displaced from tub 20 such that pieces and chunks can fall free, while powder is released into the air.

System 10 is configured to recapture the pieces and chunks in a manner such that the pieces and chunks remain clean and reusable, in addition to removing airborne powder particles at their source before they can travel into the surrounding atmosphere. Specifically, large chunks, such as block 26, fall onto grate 14 such that they can be replaced into tub 20. Smaller broken-off pieces fall through grate 14 where they are caught by a screen within enclosure 16. Powder 24 is drawn into grate 14 by first fan 18A and trapped in a filter within enclosure 16.

FIG. 2 is a top perspective view of powder dispenser filtration system 10 of FIG. 1 showing partial views of grate 14, screen 38, and filter 40 situated above second fan 18B. Enclosure 16 is comprised of panels 28A-28D, which are joined together to form upper opening 30. Grate 14 is partially cut away to show a support system for dispenser 12 comprising a plurality of rails. Screen 38 is located beneath the support system and is partially cut away to show filter 40. Screen 38 comprises a sheet of tightly knit wires. In the depicted embodiment, filter 40 comprises a plurality of corrugated fiber sheets supported by a lattice structure. Filter 40 is partially cut away to show second fan 18B and grill 36B.

First fan 18 is positioned inside panel 28A adjacent first lower opening 34, which is covered by grill 36A. Second fan 18B is supported within enclosure 16 by first fan 18A and a third fan (FIG. 3). Upper opening 30 is covered by grate 14, which includes grid members 44 arranged in a lattice system to form openings 46. In one embodiment, grate 14 comprises a structure having 1-inch by 1-inch (2.54 cm by 2.54 cm) openings, similar to that of a ceiling grid tile. Grate 14 is supported in opening 30 by rails 48A-48D, which are arranged as a rectilinear frame just below upper opening 30. For example rails 48A and 48C extend all the way across panels 28A and 28C, while rails 48B and 48D extend all the way across panels 28B and 28D underneath rails 48A and 48C. In one embodiment, rails 48A-48D comprise aluminum angles. Rails 48A-48D are connected to panels 28A-28D, respectively, using any suitable means, such as mechanical fasteners, glue or adhesive. In other embodiments, rails may be integrally molded into plastic panels.

Rails 48A and 48B carry support rails 50A and 50B, which carry cross-member rails 52A and 52B. In the embodiment shown, support rails 50A and 50B comprise aluminum angles that are mechanically fastened to the underside of rails 48A and 48B. In the embodiment shown, cross-member rails 52A and 52B comprise aluminum angles having notches such that one side of the angle fits between support rails 50A and 50B while the other side of the angle spans all the way across the tops of support rails 50A and 50B. Mechanical fasteners are used to secure cross-member rails 52A and 52B to support rails 50A and 50B in the embodiment shown. As shown in FIG. 1, cross-member rails 52A and 52B are spaced laterally approximately the length of tub 20, and support rails 50A and 50B are spaced laterally approximately the width of tub 20. An opening is provided within grate 14 with approximately the same length and width dimensions. As such, flange 22 rests atop grate 14 above support rails 50A and 50B and cross-member rails 52A and 52B when powder dispenser 12 is in place. In other embodiments of the invention, powder dispenser 12 can be integrally formed with grate 14 as a single piece. In such an embodiment, rails 50A, 50B, 52A and 52B can be reduced in number or eliminated.

Screen 38 is positioned beneath grate 14, filter 40 is located below screen 38, and grill 36B of second fan 18B is positioned beneath filter 40. Screen 38 comprises any mesh screen that permits powder or dust sized particles to pass through, such as an 18×14 or 16×16 mesh sized screen, which indicates the number of wires per inch on the warp and weft. For example, screen 38 may comprise a typical screen from a door or window. Filter 40 comprises any filter suitable for capturing typical chalk powder or dust sizes. For example, filter 40 may comprise a HEPA (high efficiency particulate air) filter capable of capturing 99.97% of particles having a diameter of 0.3 micrometers (μm) or larger. In one embodiment, filter 40 comprises a conventional furnace filter.

Grate 14, screen 38 and filter 40 provide a three-tiered recycling and filtration system. Grate 14, screen 38 and filter 40 are supported in a stacked configuration within enclosure 16. Grate 14 and screen 38 use gravity to trap solidified powder pieces from passing down to the bottom of enclosure 16 such that the pieces can be recycled. The fans within enclosure 16 draw powder particles into enclosure 16 where the particles become trapped in filter 14 before entering the surrounding atmosphere. In other embodiments, enclosure 16 may be replaced by a frame structure that supports grate 14, screen 38 and filter 40 in a stacked manner, particularly when a single, high-capacity fan is employed.

FIG. 3 is a cross-sectional view of powder dispenser filtration system 10 taken at section 3-3 of FIG. 2 showing airflow through system 10. Enclosure 16 comprises panels 28A-28D and rails 48A, 48C, 52A and 52B and 52A, as discussed above. Enclosure 16 also includes second fan 18B, third fan 18C, second lower opening 54, floor panel 56, screen rails 58A and 58B, filter rails 60A and 60B, hinges 62A-62C and power supply box 64 In FIG. 3, grate 14 and dispenser 12 are removed for simplicity.

As mentioned above, the disclosed embodiment utilizes three box fans. With reference to fan 18C, each fan includes a central motor about which fan blades 70 are configured to rotate when the motor is activated. The motor and fan blades 70 are enclosed in a box structure that includes front grill 36C and back grill 36D. First fan 18A is mounted to the interior of enclosure 16 adjacent first lower opening 34. Third fan 18C is mounted to the interior of enclosure 16 adjacent second lower opening 54. As such, fans 18A and 18C are vertically mounted so as to be generally parallel to openings 34 and 54. Foam sealant 66 encircles fans 18A and 18C to prevent airflow between panels 28A and 28C and fans 18A and 18C, respectively. Fans 18A and 18C can also be mechanically secured to the panels such that the fans can be removed, cleaned and replaced. Fan 18B is mounted to the top or upper ends of fans 18A and 18C and mechanically secured. Fan 18B is mounted in close proximity to filter 40 in a horizontal configuration. Fan 18B may alternatively be mounted directly to panels 28A and 28C.

Fans 18A, 18B and 18C each include a power cord that is connected to power supply box 64. Box 64 extends through an opening in panel 28B such that it is accessible from outside of enclosure 16. Box 64 may comprise a power strip or a power bus to which the fan power cords can be connected. With power to fans 18A-18C activated, the fans operate to draw air through enclosure 16. Fan 18B is oriented such that the fan blades pull air A from above opening 30 through grate 14, screen 38 and filter 40. Once inside enclosure 16, air A is pulled by fans 18A and 18C toward panels 28A and 28C, respectively. Fans 18A and 18C are oriented to push air A through lower openings 34 and 54, respectively. As such, fans 18A-18C act in concert to draw air A through filter 40.

Fans 18A-18C generate sufficient airflow to draw substantially all powder particles that are in close proximity to grate 14. For example, the capacity of fans 18A-18C is selected to draw in particles suspended in air within approximately one foot (˜30.48 cm) of grate 14. Airflow through enclosure 16 can be adjusted by operating fans 18A-18C individually. For example, one of more of the fans can be powered off or one or more of the fans can be set to a low power setting using individual fan controls provided on each fan, as are typically found on conventional box fans. Likewise, system 10 can be configured to have only a single fan. For example a single, high-powered industrial or commercial fan could be mounted in a horizontal or vertical orientation within enclosure 16 at a position to produce airflow as diagrammed in FIG. 3. Fans 18A-18C can be powered off to perform maintenance of system 10.

FIG. 4 is a cross-sectional view of powder dispenser filtration system 10 taken at section 4-4 of FIG. 1 showing grate 14, screen 38 and filter 40 supported on rails 58A and 58B and 60A and 60B, respectively. In FIG. 4, grate 14 and dispenser 12 are removed for simplicity, and panel 28D is opened on hinges 62A-62D to show the interior of enclosure 16. Panel 28D is partially cut away and screen 38 and filter 40 are shown partially extended from rails 58A and 58B and 60A and 60B, respectively.

Power supply box 64 includes a cord or cable external to enclosure 16 that can be plugged into a power outlet or some other power supply. Power supply box 64 also includes a switch such that power to fans 18A-18C can be easily and conveniently controlled. Power to box 64 is turned off to stop rotation of blades 70. Panel 28D is rotated on hinges 62A-62C so that the interior of enclosure 16 is readily accessible. A latch can be provided on enclosure 16 so that undesirable opening of panel 28D is prevented. With panel 28D rotated approximately ninety degrees, screen 38 and filter 40 are slid on rails 58A and 58B and 60A and 60B so as to be removed from enclosure 16.

Screen 38 rests on rails 58A and 58B, and filter 40 rests on rails 60A and 60B. When panel 28D is opened, screen 38 may be slid out of enclosure 16 on rails 58A and 58B. Small pieces of chalk that have passed through grate 14 and collected on screen 28 can then be recycled. For example, screen 38 can be transported to the vicinity of tub 20 and the collected pieces can be dumped into dispenser 12. Similarly, filter 40 rests on rails 60A and 60B and can be slid out of enclosure 16 for cleaning or replacement.

The present invention provides advantages over previous powder dispenser systems. For example, the present invention can be fabricated from readily available components and is thus considerably cheaper than previous systems. Additionally, fans 18A-18C remove powder particles from the atmosphere of the gymnasium at the source where they are produced, thereby preventing the particles from spreading into the atmosphere. The powder dispenser filtration system of the present invention also captures, using grate 14 and screen 38, solid powder pieces that would fall to the floor and become crushed and dirty in other systems. Thus, the solid pieces can be recycled and the gymnasium is not dirtied when the present invention is employed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A powder dispensing system comprising:
an enclosure having an upper opening and a first lower opening;
a grate extending across the upper opening;
a tub for holding powder being supported by the grate;
an air filter supported within the enclosure beneath the grate; and
a first fan coupled to the housing and configured to force air from the enclosure through the first lower opening.

2. The powder dispensing system of claim 1 wherein the enclosure further comprises:
a first set of rails upon which the filter is slidingly disposed; and
a door covering an access opening extending through the enclosure;
wherein the filter is configured to be slid on the first set of rails and removed from the enclosure when the door is opened.

3. The powder dispensing system of claim 1 and further comprising:
a screen disposed beneath the grate and the tub and above the filter.

4. The powder dispensing system of claim 3 wherein:
the grate has first sized openings;
the screen has second sized openings smaller than the first sized openings; and
the filter has third sized openings smaller than the second sized openings.

5. The powder dispensing system of claim 3 wherein the enclosure further comprises:
a first set of rails upon which the screen is slidingly disposed;
a second set of rails upon which the filter is slidingly disposed; and
a door covering an access opening extending through the enclosure;
wherein the screen and filter are configured to be removed from the enclosure when the door is opened.

6. The powder dispensing system of claim 1 and further comprising:
a second lower opening in the enclosure; and
a second fan coupled to the housing and configured to force air from the enclosure through the second lower opening.

7. The powder dispensing system of claim 6 and further comprising:
a third fan disposed between the first and second fans and the filter and configured to draw air into the enclosure through the upper opening.

8. The powder dispensing system of claim 7 wherein:
the first fan is disposed within the housing adjacent the first lower opening;
the second fan is disposed within the housing adjacent the second lower opening; and
the third fan positioned on top of the first and second fans below the upper opening.

9. The powder dispensing system of claim 7 wherein the third fan is configured to draw ambient air into the enclosure through the upper opening and the filter, and the first and second fans are configured to push air out of the enclosure through the first and second lower openings, respectively.

10. The powder dispensing system of claim 1 and further comprising:
an opening in the grate; and
a flange extending around the tub such that the flange supports the tub on the grate and the grate forms an apron surrounding the tub.

11. The powder dispensing system of claim 1 wherein the enclosure comprises:
a four-side panel box forming the upper opening at a top end; and
a floor panel located at a bottom end of the four-side panel box;
wherein the first lower opening extends through one side panel of the box.

12. The powder dispensing system of claim 11 wherein the first fan is positioned within the enclosure adjacent the first lower opening and an interface between the first fan and the panel of the box through which the first lower opening extends is sealed.

13. A powder dispenser filtration system comprising:
a frame;
an apron supported by the frame;
a powder bin supported by the apron;
a grid extending across an opening in the apron;
a filter supported beneath the grid by the frame; and
a fan coupled to the frame and configured to draw air through the grid and the filter.

14. The powder dispenser filtration system of claim 13 and further comprising:
a first set of rails mounted to the frame and upon which the filter is slidingly disposed.

15. The powder dispenser filtration system of claim 14 and further comprising:
a second set of rails mounted to the frame between the apron and the first set of rails; and
a screen slidingly disposed on the second set of rails.

16. The powder dispenser filtration system of claim 15 wherein:
the filter comprises an air filter having openings approximately 0.1 mm in width or smaller;
the grid includes openings approximately 1.0 cm in width or larger; and
the screen includes openings sized between those of the filter and grid.

17. The powder dispenser filtration system of claim 15 wherein the frame comprises:
a housing that forms an enclosure supporting the apron and the first and second sets of rails;
an opening through the enclosure in which the fan is disposed; and
a door covering an access opening through the enclosure;
wherein the screen and the filter are configured to be removed from the enclosure when the door is opened.

18. A powder dispenser filtering system comprising:
a housing having a top opening;
a vent disposed within the housing;
a powder bin having a top-located access point;
a grate positioned within the airflow and extending laterally from the powder bin to support the powder bin in the top opening;
a filter positioned within the housing;
a first fan disposed within the housing and configured to draw an airflow into the top opening, through the grate and through the filter; and
a vent disposed within the housing through which the airflow exits the housing.

19. The powder dispenser filtering system of claim 18 and further comprising a screen positioned between the grate and the filter.

20. The powder dispenser filtering system of claim 18 and further comprising:
a second fan;
wherein the first fan is positioned approximately parallel to the vent to force air out of the housing; and
wherein the second fan is positioned approximately parallel to the top opening to force air into the housing.
